(19) United States
(12) Patent Application Publication
(10) Pub. No.: US 2013/0060722 A1
(43) Pub. Date: Mar. 7, 2013

(54) Method of generating revenue for a governmental entity

(71) Applicant: Chris M. Ohman, Tulsa, OK (US)

(72) Inventor: Chris M. Ohman, Tulsa, OK (US)

(21) Appl. No.: 11/267,552

(22) Filed: Nov. 4, 2005

Related U.S. Application Data
(60) Provisional application No. 60/625,990, filed on Nov. 8, 2004.

(51) Int. Cl. G06Q 90/00; G06Q 50/26

(52) U.S. Cl. 705/500

(57) ABSTRACT

A method of generating revenue for a governmental entity is achieved by identifying a stationary structure supporting a traffic information sign on a first side; making provisions for inclusion of commercial advertisement on an unused second side portion of the stationary structure; executing a licensing agreement between an interested party and the governmental entity for use of the unused second side portion of the stationary structure for commercial advertisement, wherein the executed licensing agreement includes an agreed upon royalty payable to the governmental entity; applying a commercial advertisement on the unused second side portion of the stationary structure; and collecting the agreed upon royalty from the interested party to generate revenue for the governmental entity.

### RELATED APPLICATIONS

This application claims domestic priority under 35 U.S.C. §119(e) to U.S. Provisional Application No. 60/625,990 filed Nov. 8, 2004, entitled Method Of Generating Revenue For A Governmental Entity.

### BACKGROUND OF THE INVENTION

1. Field of the Invention

The present invention relates to revenue generation for a governmental entity. More particularly, but not by way of limitation, the present invention relates to a commercialization of unused portions of governmentally controlled stationary structures, such as a highway sign support structures, for use in supporting commercial advertisements.

2. Background of the Invention

Opportunities for governmental agencies to generate revenues, other than through regulatory, processing, and licensing fees or taxation are limited. Often, the ability to increase fees or taxes relies on a statutory mandate and may necessitate voter approval, either of which may prove to be a daunting task.

As governmental costs escalate, pressures continue to be placed on governmental officials to reduce operating costs, while maintaining and improving the level and quality of services provided. As such, challenges remain and a need persists for improvements in techniques and methods for generating revenue streams for governmental entities that are not fee or tax based, and to which the present invention is directed.

### SUMMARY OF THE INVENTION

In accordance with a preferred embodiment, a method of generating revenue for a governmental entity is claimed. The method preferably includes: identifying a stationary structure, such as a highway sign support structure, used to support traffic route information signs on a first side; and making provisions for inclusion of commercial advertisement on an unused second side portion of the stationary structure. Frequently, traffic route information signs provide motorists with information regarding upcoming traffic routes. In a preferred embodiment the steps further include; executing a licensing agreement between an interested party and the governmental entity for use of the unused second side portion of the stationary structure for commercial advertisement, wherein the executed licensing agreement includes an agreed upon royalty payable to the governmental entity; applying a commercial advertisement on the unused second side portion of the stationary structure; and collecting the agreed upon royalty from the interested party to generate revenue for the governmental entity.

These and various other features and advantages which characterize the claimed invention will be apparent from reading the following detailed description and a review of the associated drawings.

### BRIEF DESCRIPTION OF THE DRAWINGS

FIG. 1 shows a perspective, elevational view of a stationary structure of a type incorporated by the present invention.

FIG. 2 provides a perspective, elevational view of an embodiment of the present invention.

FIG. 3 is a flow diagram of a method of practicing an embodiment of the present invention.

### DESCRIPTION OF THE PREFERRED EMBODIMENTS

Before explaining the present invention in detail, it is important to understand that the invention is not limited in its application to the details of the construction illustrated, or by the steps of construction inherently present by way of illustration of the appended drawings. The invention is capable of other embodiments and of being practiced or carried out in a variety of ways. It is to be understood that the phraseology and terminology employed herein is for the purpose of description and does not impose limitation on the present invention.

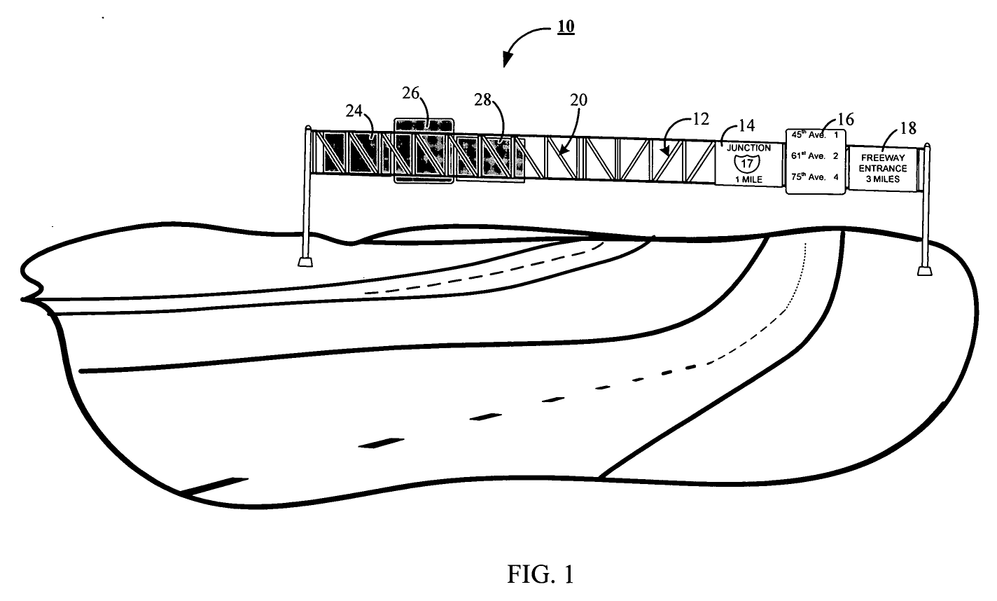

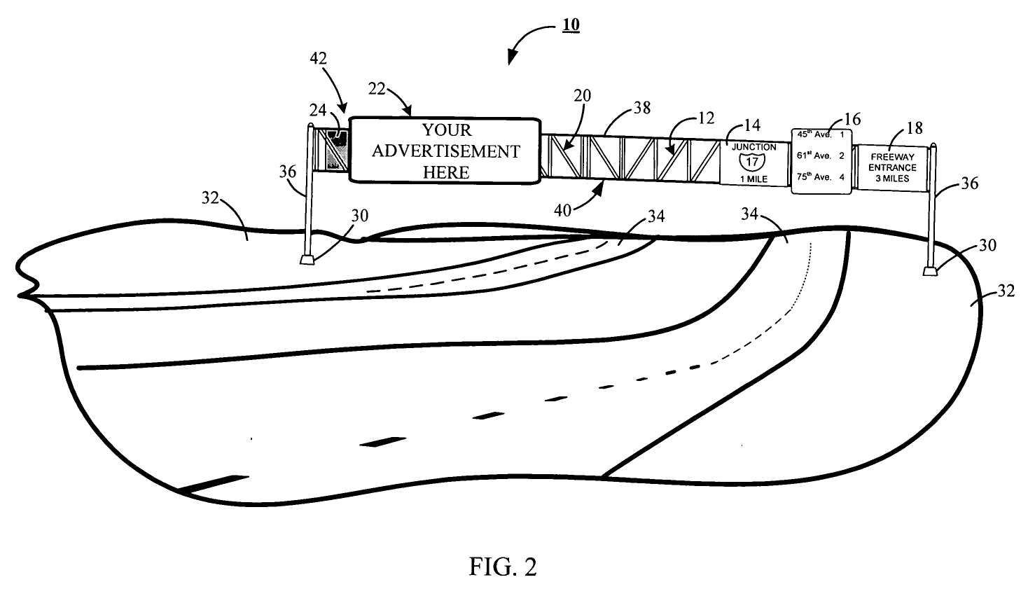

Referring now to the drawings, wherein like reference numerals indicate the same parts throughout the several views, a stationary support structure, preferably a traffic sign support structure 10 (also referred to herein as stationary structure 10), shown by FIG. 1, provides a host structure for practicing the present invention. Preferably, stationary structure 10 includes: at least a first side portion 12 for use in supporting traffic route information sign 14, and may support additional traffic route information signs such as 16, and 18; and at least a second side portion 20 for use in supporting a commercial advertisement sign 22, as shown by FIG. 2.

In a preferred embodiment, the commercial advertisement sign 22 of FIG. 2 is depicted as a structural member communicating with the stationary structure 10. In an alternate preferred embodiment, a commercial advertisement is applied to a back side of traffic route information sign 24, and may be applied to a back side of traffic route information signs 26, and 28 as shown by FIG. 1.

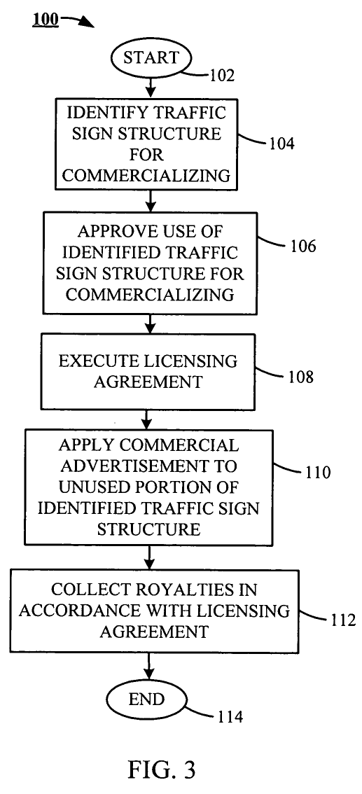

FIG. 3 shows a flow chart 100 of steps included within a method of practicing a preferred embodiment of the present invention. The method commences at start process step 102, and continues at process step 104. At process step 104, an authorized governmental entity identifies for commercialization a stationary structure, such as a highway sign support structure (such as 10) used to support traffic route information signs (such as 14, 16, and 18) on a first side portion (such as 12). At process step 106, the authorized governmental entity assures that statutory or regulatory provisions are made for inclusion of commercial advertisement on an unused second side portion (such as 20) of the stationary structure. With the proper authorization in place, at process step 108, the governmental entity enters into negotiations leading to an executed licensing agreement between an interested party and the governmental entity for the use by the interested party of the unused portion of the stationary structure for support of a commercial advertisement sign (such as 22), in exchange for royalty payments from the interested party. At process step 110, the commercial advertisement is applied to the unused portion of the stationary structure, and at process step 112, royalty payments are collected by the governmental entity. The method shown by flow chart 100 concludes at end process step 114.

Returning to FIG. 2, shown therein is a stationary support 30, anchored to the ground 32. In a preferred embodiment, the stationary support 30 is formed from concrete, and is located a predetermined distance from a thoroughfare, such as 34. Preferably, a support post 36 is secured to the stationary support 30, and is configured to maintain traffic routing signs, such as 14, 16, and 18 a predetermined distance above the ground 32.

In a preferred embodiment, a truss 38 is secured to the support post 36, and is configured to support the traffic routing signs 14, 16, and 18 on a first side 40, and traffic routing sign 24 on a second side 42. The truss 38 is further to support the traffic signs 14, 16, 18, and 24 at the predetermined distance above the ground 32, and preferably, the stationary support 30, support post 36, and truss 38 collectively for the stationary structure 10.

As will be apparent to those skilled in the art, a number of modifications could be made to the preferred embodiments which would not depart from the spirit or the scope of the present invention. While the presently preferred embodiments have been described for purposes of this disclosure, numerous changes and modifications will be apparent to those skilled in the art. Such changes and modifications are encompassed within the spirit of this invention.

1. A method of generating revenue for a governmental entity by steps comprising:
identifying a stationary structure supporting a traffic route information sign on a first side;
making lawful provisions for inclusion of commercial advertisement on an unused second side portion of the stationary structure, wherein lawful provisions are selected from a group consisting of regulatory provisions and statutory provisions;
executing a licensing agreement between an interested party and the governmental entity for use of the unused second side portion of the stationary structure for commercial advertisement, wherein the executed licensing agreement includes an agreed upon royalty payable to the governmental entity;
securing a commercial advertisement on the unused second side portion of the stationary structure; and
collecting the agreed upon royalty from the interested party to generate revenue for the governmental entity.

2. The revenue generation method of claim 1, in which identifying a stationary structure includes a step of determining a static load bearing ability of a support post supporting said traffic route information sign for use in deciding whether said commercial advertisement may be applied to said stationary structure.

3. The revenue generation method of claim 1, in which identifying a stationary structure includes a step of determining a static load bearing ability of a truss supporting said traffic route information sign for use in deciding whether said commercial advertisement may be applied to said stationary structure.

4. The revenue generation method of claim 1, in which identifying a stationary structure includes a step of determining a static load bearing ability of a support post and truss combination supporting said traffic route information sign for use in deciding whether said commercial advertisement may be applied to said stationary structure.

5. The revenue generation method of claim 1, in which identifying a stationary structure includes a step of determining a dynamic load bearing ability of a support post supporting said traffic route information sign for use in deciding whether said commercial advertisement may be applied to said stationary structure.

6. The revenue generation method of claim 1, in which identifying a stationary structure includes a step of determining a dynamic load bearing ability of a truss supporting said traffic route information sign for use in deciding whether said commercial advertisement may be applied to said stationary structure for use in deciding whether said commercial advertisement may be applied to said stationary structure.

7. The revenue generation method of claim 1, in which identifying a stationary structure includes a step of determining a dynamic load bearing ability of a support post and truss combination supporting said traffic route information sign.

8. The revenue generation method of claim 4, in which securing a commercial advertisement includes a step of securing a commercial advertisement sign to said identified stationary structure when said static load bearing ability of said support post and truss combination is capable of safely supporting said commercial advertisement sign.

9. The revenue generation method of claim 8, in which securing a commercial advertisement includes a step of applying said commercial advertisement to said commercial advertisement sign.

10. The revenue generation method of claim 7, in which securing a commercial advertisement includes a step of securing a commercial advertisement sign to said identified stationary structure when said dynamic load bearing ability of said support post and truss combination is capable of safely supporting said commercial advertisement sign.

11. The revenue generation method of claim 10, in which securing a commercial advertisement includes a step of applying said commercial advertisement to said commercial advertisement sign.

12. A method of generating revenue for a governmental entity by steps comprising:
anchoring a stationary support to earth;
sizing a support post and truss combination to accommodate a traffic route information sign on a first side of said truss and an commercial advertisement sign on a second side of said truss;
making lawful provisions for inclusion of commercial advertisement on an unused second side portion of the stationary structure, wherein lawful provisions are selected from a group consisting of regulatory provisions and statutory provisions;
securing said support post and truss combination to said stationary support;
executing a licensing agreement between an interested party and the governmental entity for use of said second side of said truss, wherein said executed licensing agreement includes an agreed upon royalty payable to the governmental entity;
securing said traffic route information sign to said first side of said truss;
attaching said commercial advertisement sign on said second side of said truss;
applying a commercial advertisement on said commercial advertisement sign; and
collecting the agreed upon royalty from the interested party to generate revenue for the governmental entity.

13. (canceled)

14. The revenue generation method of claim 12, in which said traffic route information sign provides a front side and a back side, and by steps further comprising:
displaying traffic route information on said front side of said traffic route information sign; and
applying a second commercial advertisement on said back side of said traffic route information sign.

15. The revenue generation method of claim 12, in which said stationary support together with said support post and truss combination form a stationary structure.

16. The revenue generation method of claim 12, in which said sizing a support post and truss combination includes a step of determining a static load bearing ability of said support post and truss combination for use in deciding whether said commercial advertisement sign may be attached to said second side of said truss.

17. The revenue generation method of claim 12, in which said sizing a support post and truss combination includes a step of determining a dynamic load bearing ability of said support post and truss combination for use in deciding whether said commercial advertisement sign may be attached to said second side of said truss.

18. The revenue generation method of claim 16, in which said commercial advertisement sign is attached to said second side of said truss when said static load bearing ability of said support post and truss combination is capable of safely supporting said commercial advertisement sign.

19. The revenue generation method of claim 17, in which said commercial advertisement sign is attached to said second side of said truss when said dynamic load bearing ability of said support post and truss combination is capable of safely supporting said commercial advertisement sign.

20. A combination comprising:
a stationary support anchored to the ground;
a support post attached to said stationary support, said support post configured to maintain a traffic routing sign a predetermined distance above the ground;
a truss secured to said support post, said truss configured to support said traffic routing sign at said predetermined distance above the ground, wherein said stationary support, support post, and truss collectively for a stationary structure; and
steps for generating revenue for a governmental entity from use of said stationary structure for commercial advertisement.
